(19) United States
(12) Patent Application Publication
(10) Pub. No.: US 2006/0041396 A1
(43) Pub. Date: Feb. 23, 2006

(54) Off-road detection for improving tire pressure loss detection

(76) Inventor: Norbert Polzin, Zaberfeld (DE)

Correspondence Address: KENYON & KENYON, ONE BROADWAY, NEW YORK, NY, 10004, US

(21) Appl. No.: 10/509,707

(22) PCT Filed: Feb. 7, 2003
(86) PCT No.: PCT/DE03/00353

§ 371 Date: Jul. 28, 2005

(30) Foreign Application Priority Data
Mar. 30, 2002 (DE) 102 14 455.9

(51) Int. Cl. G06F 19/00

(52) U.S. Cl. 702/113

(57) ABSTRACT

A method and a device for monitoring a tire condition of a vehicle provide for a malfunction being detected as a function of the condition of the surface on which the vehicle is traveling, the detection occurs in at least two different, independent monitoring modes. Each monitoring mode is assigned a calibration data set based on a wheel dynamics variable representing the tire condition. Monitoring occurs by comparing the current wheel dynamics variable with the relevant calibration data set. Should a malfunction be detected during monitoring of the tire condition, the driver is informed thereof.

### FIELD OF THE INVENTION

The present invention relates to a method and a device for monitoring the tire condition of a vehicle.

### BACKGROUND INFORMATION

Systems for detecting a tire condition are known from other systems. Besides the direct determination of the air pressure of a tire, rotational speeds of the wheels may be used to determine changes in tire pressure.

Changes in the rotational speeds of individual wheels may be determined and used for indicating the change in the condition of the tires. Systems that indicate the tire condition under certain operational conditions (unbraked, unaccelerated straight-ahead driving) are discussed in German Published Patent Application No. 36 10 116 and German Patent No. 32 36 520. Also discussed in these documents is normalization of the rotational speeds to the vehicle speed.

Using differences between the rotational speeds of individual wheels for recognizing tire condition is discussed in European Patent No. 0 291 217.

German Published Patent Application No. 199 44 391 discusses the adaptation of a calibration value used for monitoring tire pressure. Here, recalibration of the tire pressure system is performed based on a changed operational condition of the wheel, the old value being overwritten.

### SUMMARY OF THE INVENTION

The present invention provides a method and a device for monitoring the tire condition of a vehicle, the tire pressure on the wheels of the vehicle, in particular, being monitored. The core of the present invention lies in the fact that monitoring of the tire condition depends on the condition of the surface on which the vehicle is traveling. According to the present invention, this results in an improved pressure loss display based on the transmission of force between the vehicle wheels and the road surface which changes to a lesser or higher degree when traveling under constantly changing road friction values on the wheels.

One exemplary embodiment provides for the monitoring to occur in at least two different, independent monitoring modes depending on the driving surface. The different monitoring modes differ from one another in that each uses a separate calibration data set as a reference data set.

One exemplary embodiment of the present invention relates to the determination of the condition of the driving surface using a signal representing the transmission of force between the wheels of the vehicle and the driving surface. In particular, this signal involves the transmission of force between the wheels of the vehicle and the driving surface to occur via time averaging in order to equalize short-term disturbances or short-term changes in the condition of the driving surface.

Another exemplary embodiment of the present invention relates to the determination of the different calibration data sets that are used as reference data sets for monitoring the tire condition. The calibration data sets are determined here as a function of a signal representing the transmission of force between the wheels of the vehicle and the driving surface, and/or a command initiated by the driver of the vehicle. In particular, the signal may be generated by a system outside of the actual monitoring device according to the present invention. The driver may start the initialization of the applicable calibration data set by manually actuating a switch, for instance.

For the purpose of monitoring the tire condition, one exemplary embodiment of the present invention compares the wheel dynamics variable representing the wheel dynamics with one another at different points in time. In particular, the wheel dynamics variable is to be represented by the wheel rotational speed and thus by the rotational speed of the wheels. For this reason, the wheel rotational speeds are determined at regular intervals for determining the velocity of the wheels.

In one exemplary embodiment of the present invention, the wheel dynamics variable representing the tire condition is now to be determined by forming a difference between the wheel rotational speeds of at least two wheels. In particular, the differences between the rotational speeds of the wheels on one axle and/or of diagonally arranged wheels are to be formed. In another exemplary embodiment of the present invention, the wheel rotational speeds on one axle may initially be added up.

In a further exemplary embodiment of the present invention, the difference between the sum of the wheel rotational speeds of the wheels on the front axle and the sum of the wheel rotational speeds of the wheels on the rear axle may be formed. The resulting difference is subsequently normalized to the vehicle speed. In another, comparable difference-forming method, first the sum of the wheel rotational speeds of the wheels on the right side is formed, and the sum of the wheel rotational speeds of the wheels on the left side is subtracted from the former. The resulting difference may then also be normalized to the vehicle speed.

The difference is formed by forming the wheel rotational speed differences between the front and the rear wheels, as well as between the wheels on the right and the left side, normalized in each case to the vehicle speed.

In a further exemplary embodiment of the present invention, the calibration data sets are determined and stored on the basis of the calculated differences between the wheel rotational speeds, as a function of the condition of the driving surface or the associated transmission of force between the wheels of the vehicle and the driving surface and/or a command initiated by the driver of the vehicle. In particular, the driver may initiate the determination and storage of the calibration data set—by manually actuating a switch for example—if he detects, for instance, that he is about to drive off-road.

The present invention provides for a method and a device for monitoring the tire condition, where the currently calculated wheel rotational speed differences are compared with the applicable, driving surface-dependent calibration data set. Should the current wheel rotational speed differences lie outside of a predefined range in relation to the applicable calibration data set, the monitor detects a malfunction. If a malfunction occurs, the driver of the vehicle may be informed of the change in the tire condition, in particular via an optical or acoustic display.

In another exemplary embodiment of the present invention, the occurrence of a malfunction is used to modify a brake system in the vehicle in such a manner that critical driving conditions are avoided and at least the tire is damaged to a lesser degree. The functions of other vehicle systems, as well, are modifiable in response to a malfunction. For instance, in the event of a detected malfunction such as low tire pressure, the speed of the vehicle may be restricted.

In an exemplary embodiment of the present invention, the tire condition is to be monitored via the air pressure in a tire and/or the wear condition of a tire.

### BRIEF DESCRIPTION OF THE DRAWINGS

FIG. 1 shows a schematic view of the recording of the performance variables for calibrating and monitoring the tire condition of the vehicle, as well as the relaying of the malfunction information.

FIG. 2 shows, in the form of a flow chart, the initialization of the system and the storing of the calibration data sets for the two monitoring modes.

FIG. 3 shows, in the form of a flow chart, a monitoring of the tire condition in the two monitoring modes.

### DETAILED DESCRIPTION

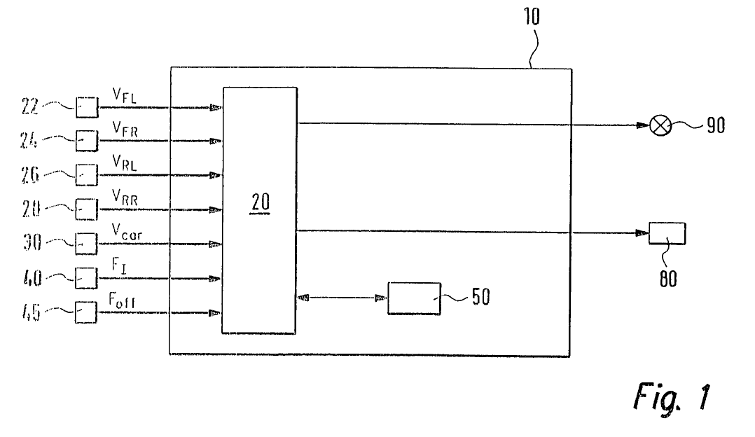

FIG. 1 shows an exemplary embodiment for monitoring the tire condition of a vehicle, to be understood, in particular, as the monitoring of the tire pressure based on the measured speeds of the vehicle wheels. Block 10 contains monitoring unit 20 and memory 50.

Monitoring unit 20 receives speed signals representing the wheel velocities of the vehicle wheels. In order to simplify the layout, FIG. 1 shows only the speed signals of the left wheel v_{FL} (22) and the right wheel v_{FR} (24) on the front axle and the left wheel v_{RL} (26) and the right wheel v_{RR} (28) on the rear axle. An extension to several axles, as well as additional wheels per axle, is easy, however. In addition to the speed signals of the wheels, the overall speed of the vehicle is read in via speed signal v_{car} (30). Furthermore, in block 20, the state of an initialization is interrogated via an F₁ flag (40) and the state of the condition of the driving surface is interrogated via an F_{off} flag (45), the set F₁ flag=1 corresponding to the request for performing an initialization of the system for example by the driver of the vehicle. However, the condition of the driving surface may be determined independently of the driver, and the F₁ flag may be set as a function of the driving surface condition thus determined.

The condition of the driving surface plays an important role in the transmission of force between the wheels of the vehicle and the driving surface. When driving on a road such as a paved surface having high and uniform transmission of force between the wheels of the vehicle and the driving surface, the transmission of force has a normal value under these “normal conditions.” Should the transmission of force decrease in relation to the normal value—such as during off-road driving—below a threshold value, the F_{off} flag=1 is set by an external system arranged outside block 10. The driver of the vehicle may set the flag manually. A set F_{off} flag corresponds to driving under off-road conditions distinct from driving under “normal conditions.”

The calibration data sets generated after initialization may be stored in block 50 as reference values for monitoring the tire condition.

Should a malfunction of the tire condition be detected in block 20, this information may be relayed to the driver either acoustically or optically via an appropriate display (90). In addition, the malfunction of the tire condition is also usable for intervening in the vehicle dynamics such as in an ESP-system (80) for improving the driving stability.

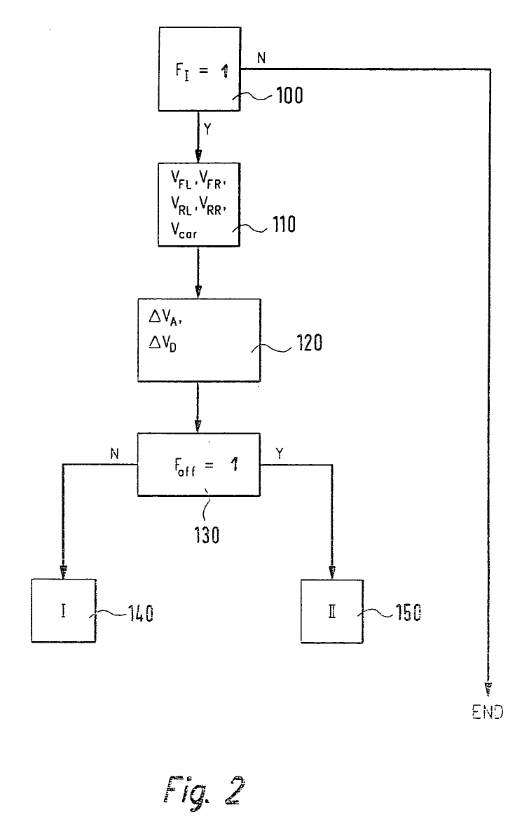

FIG. 2 shows an exemplary embodiment of the initialization of the system for monitoring the tire condition, and the tire pressure in particular. In step 100, flag F₁ is interrogated at regular intervals. If a set flag F₁ is detected, the initialization of the system is started via the generation of a calibration data set. Otherwise the program is terminated until the next start. In step 110, the speed signals v_{FL}, v_{FR}, v_{RL}, v_{RR} of the individual wheels are read in, as well as the vehicle speed via v_{car}. For instance, the vehicle speed is determinable from the averaged wheel rotational speeds in a generally known manner. The differences in the wheel speeds are formed via these speed signals.

In this exemplary embodiment, the wheel velocity differences are formed by forming the difference between the sum of the wheel rotational speeds of the wheels on the front axle and the sum of the wheel rotational speeds of the wheels on the rear axle, normalized to the vehicle speed according to
Δv_{A}:={(v_{FL}+v_{FR})−(v_{RL}+v_{RR})}/v_{car}
The difference may also be formed by deducting the sum of the wheel rotational speeds of the wheels on the left side from the sum of the wheel rotational speeds of the wheels on the right side. The resulting difference may then also be normalized to the vehicle speed according to
Δv_{D}:={(v_{FL}+v_{RR})−(v_{FR}+v_{RL})}/v_{car}
Furthermore, any other method of forming the difference between the wheel velocities is conceivable.

If the system detects—via set flag F_{off} in step 130—that the vehicle is traveling with reduced transmission of force between the vehicle wheels and the driving surface, the determined differences in wheel speeds are stored as calibration data set II (150) in monitoring mode II. If the vehicle is traveling under “normal conditions,” i.e., flag F_{off} is not set, the determined differences in wheel velocities are stored as calibration data set I (140) in monitoring mode I.

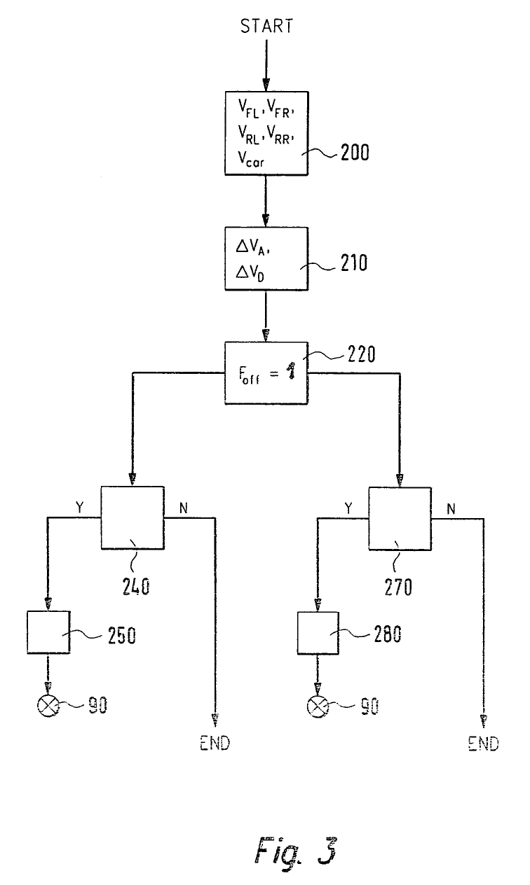

FIG. 3 shows an exemplary embodiment of the detection of a malfunction in monitoring the tire condition, in particular the tire pressure of a vehicle. The sketched program is started at predefined cycles throughout the entire operation. The flow chart compares the actually determined instantaneous differences in wheel velocities with the calibration data sets in the two monitoring modes.

In step 200, speed signals v_{FL}, v_{FR}, v_{RL}, v_{RR} and v_{car} are read in. Using these speed signals, the differences in wheel velocities are formed in step 210 according to step 120 in FIG. 2. If the system detects that the vehicle is traveling with reduced transmission of force between the wheels of the vehicle and the driving surface via set flag F_{off} in step 220, it compares the differences in wheel velocities determined in step 210 with calibration data set II in step 270. Should the deviation of the two values exceed a predefinable amount, a malfunction, in particular a tire pressure loss, is detected in step 280 and brought to the attention of the driver via an acoustical or optical display (90). If the deviation lies within the predefined limits, the program is terminated and restarted during the next cycle.

If the system detects a transmission of force between the wheels of the vehicle and the driving surface under “normal conditions,” via unset flag F_{off} in step 220, it compares the differences in wheel velocities determined in step 210 with calibration data set I in step 240. Should the deviation of the two values exceed a predefinable amount, a malfunction, in particular a tire pressure loss, is detected in step 250 and brought to the attention of the driver via an acoustical or optical display (90). If the deviation lies within the predefined limits, the program is terminated and restarted during the next cycle.

1-15. (canceled)

16. A method for monitoring a tire condition of a vehicle, comprising:
monitoring the tire condition as a function of a condition of a driving surface on which the vehicle is traveling.

17. The method of claim 16, wherein the monitoring is performed in at least two different independent monitoring modes as a function of the driving surface, the at least two different individual modes differing by different calibration data sets.

18. The method of claim 16, wherein the condition of the driving surface is defined by a signal representing a transmission of force between wheels of the vehicle and the driving surface, the signal defining a time averaging of the transmission of force between the wheels of the vehicle and the driving surface.

19. The method of claim 17, wherein the calibration data sets are determined at least one of as a function of the condition of the driving surface, as a function of a signal representing transmission of force between wheels of the vehicle and the driving surface, and a command initiated by a driver of the vehicle.

20. The method of claim 16, wherein the tire condition is monitored by using a wheel dynamics variable representing wheel dynamics.

21. The method of claim 20, wherein the wheel dynamics variable represents the wheel dynamics being determined using the wheel rotational speed.

22. The method of claim 20, wherein the wheel dynamics variable representing the tire condition is determined by forming a difference between wheel rotational speeds of at least two wheels.

23. The method of claim 20, wherein the wheel dynamics variable representing the tire condition is determined by forming a difference between wheel rotational speeds of wheels on one axle.

24. The method of claim 20, wherein the wheel dynamics variable representing the tire condition is determined by forming a difference between wheel rotational speeds of wheels located diagonally to each other.

25. The method of claim 20, wherein the wheel dynamics variable representing the tire condition is determined by forming a difference wheel rotational speeds between a sum of wheel rotational speeds of wheels on a front axle and a sum of wheel rotational speeds of wheels on the rear axle, normalized to a vehicle speed.

26. The method of claim 20, wherein the wheel dynamics variable representing the tire condition is determined by forming a difference of wheel rotational speeds between a sum of wheel rotational speeds of wheels on a left side and a sum of wheel rotational speeds of wheels on a right side, normalized to a vehicle speed.

27. The method of claim 17, wherein the calibration data sets are determined at predefinable times using differences between wheel rotational speeds.

28. The method of claim 27, wherein the predefinable times are set at least one of as a function of the condition of the driving surface, as a function of a driving surface condition variable, and by a command initiated by a driver of the vehicle.

29. The method of claim 27, wherein the monitoring of the tire condition is based on forming a difference between the wheel rotational speeds, and a malfunction is detected when currently determined differences between the wheel rotational speeds lie outside a predefined range in relation to a calibration data set valid for the condition of the driving surface.

30. The method of claim 29, wherein a driver of the vehicle is informed of an occurrence of the malfunction.

31. The method of claim 30, wherein the driver is informed of a malfunction at least one of optically and acoustically.

32. The method of claim 29, wherein an operating state of a brake system in the vehicle is modified based on the malfunction, the operating state of the brake system being characterized by variables used for the operation of the brake system.

33. A device for monitoring a tire condition of a vehicle, comprising:
an arrangement to monitor the tire condition of the vehicle;
wherein the tire condition is monitored as a function of a condition of a driving surface on which the vehicle is traveling.

34. The device of claim 33, wherein the monitoring of the tire condition is performed in at least two different independent monitoring modes, the different independent monitoring modes differing by different calibration data sets.

35. The device of claim 33, wherein the condition of the driving surface is defined by a signal representing a transmission of force between wheels of the vehicle and the driving surface, the signal defining a time averaging of the transmission of force between the wheels of the vehicle and the driving surface.

36. The device of claim 34, wherein the calibration data sets are determined as a function of the condition of the driving surface.

37. The device of claim 34, wherein the calibration data sets are determined as a function of a signal representing transmission of force between wheels and the driving surface.

38. The device of claim 34, wherein the calibration data sets are determined by a command initiated by a driver of the vehicle.

39. The device of claim 34, wherein the calibration data sets are determined at predefinable times using differences between wheel rotational speeds.

40. The device of claim 39, wherein the predefined times are determined at least one of as a function of the condition of the driving surface, as a function of the driving surface condition variable, and by a command initiated by a driver of the vehicle.

41. The device of claim 34, wherein the monitoring of the tire condition is based on forming a difference between wheel rotational speeds, and a malfunction is detected when a currently determined difference between the wheel rotational speeds lies outside a predefined range in relation to a calibration data set valid for the particular condition of the driving surface.

42. The method of claim 33, wherein the tire condition includes at least one of an air pressure prevailing in a tire and a wear condition of a tire.
